(19) United States
(12) Patent Application Publication
(10) Pub. No.: US 2014/0110994 A1
(43) Pub. Date: Apr. 24, 2014

(54) METHOD FOR OPERATING A BRAKING SYSTEM

(71) Applicants: Steffen Gruber, Kleinostheim (DE); Thorsten Ullrich, Gernsheim (DE); Scott Ross, Steinbach (DE); Thomas Peichl, Wollstadt (DE)

(72) Inventors: Steffen Gruber, Kleinostheim (DE); Thorsten Ullrich, Gernsheim (DE); Scott Ross, Steinbach (DE); Thomas Peichl, Wollstadt (DE)

(73) Assignee: Continental Teves AG & Co. oHG, Frankfurt (DE)

(21) Appl. No.: 14/111,238

(22) PCT Filed: Apr. 5, 2012
(86) PCT No.: PCT/EP2012/056334

§ 371 Date: Dec. 16, 2013

(30) Foreign Application Priority Data
Apr. 11, 2011 (DE) 102011007164.4

(51) Int. Cl. B60T 13/58; B60T 13/16

(52) U.S. Cl. CPC B60T 13/586; B60T 13/161
USPC 303/3; 303/20

(57) ABSTRACT

The invention relates to a method for operating a braking system, including a brake booster, which is divided into at least one vacuum chamber and at least one working chamber by at least one movable partition, wherein at least one vacuum chamber is connected, or can be connected, to a vacuum source for creating a vacuum, and further including at least one sensor, which detects at least one variable such as travel and/or angle and/or force of a brake pedal actuation and/or a brake pressure that is built up in at least one main brake cylinder connected to the brake booster in accordance with a brake pedal actuation. According to the invention, the remaining vacuum in at least one vacuum chamber is estimated on the basis of at least one of the detected variables by considering actuations already performed. The invention further relates to a braking system and to the use thereof.

### CROSS REFERENCE TO RELATED APPLICATIONS

This application is the U.S. National Phase Application of PCT International Application No. PCT/EP2012/056334, filed Apr. 5, 2012, which claims priority to German Patent Application No. 10 2011 007 164.4, filed Apr. 11, 2011, the contents of such applications being incorporated by reference herein.

### FIELD OF THE INVENTION

The invention relates to a method for operating a brake system having a brake booster which is divided into at least one negative-pressure chamber and at least one working chamber by at least one movable partition, wherein at least one negative-pressure chamber is or can be connected to a negative-pressure source for the build-up of a negative pressure, and having at least one sensor which detects at least one variable such as travel and/or angle and/or force of a brake pedal actuation and/or a brake pressure that is built up, in accordance with a brake pedal actuation, in at least one master brake cylinder that is connected to the brake booster, and to a brake system as per the preamble of claim 13, and to the use of the brake system in a motor vehicle.

### BACKGROUND OF THE INVENTION

Modern motor vehicles must satisfy high requirements with regard to comfort and safety. To achieve even relatively intense vehicle deceleration with reasonable pedal force effort, the actuation force applied to the brake pedal by the driver is boosted by means of the auxiliary force of a brake booster. What are particularly common are vacuum- or negative-pressure-type brake boosters which utilize a negative pressure (or the pressure difference between a negative-pressure chamber and a working chamber which is aerated in accordance with the brake pedal actuation) as an energy source. Said negative pressure may be generated or maintained by means of an intake pipe of an internal combustion engine or by means of an engine-operated vacuum pump. Without the continuous evacuation of the negative-pressure chamber(s), a vacuum-type brake booster would no longer be able to perform its function after a few braking processes, because air flows in during every braking operation.

DE 10 2007 027 768 A1, which is incorporated by reference, discloses a method for the provision of a negative pressure for a brake actuation apparatus of a motor vehicle brake system, which brake actuation apparatus comprises a pneumatic brake booster, the interior of which is divided into at least one negative-pressure chamber and one working chamber. A vacuum sensor detects a pressure level in the negative-pressure chamber and/or the pressure difference between the negative-pressure chamber and the working chamber. If a first negative-pressure level is undershot in the negative-pressure chamber (or the pressure in the negative-pressure chamber is too high), a pneumatic motor-pump assembly is activated; when a second negative-pressure level is reached (or an absolute pressure threshold value is undershot) in the negative-pressure chamber, the motor-pump assembly is deactivated.

For safety-relevant components or systems in motor vehicles, specific requirement criteria are also defined for fault scenarios and fall-back solutions, for example in ECE R13H for passenger motor vehicle brake systems. To be able to ensure a required minimum deceleration even in the event of a fault, it may therefore be necessary to identify a defect of the vacuum sensor and/or, in the case of a defective vacuum sensor, to also at least approximately determine the negative pressure in the vacuum- or negative-pressure-type brake booster. Measures for ensuring the required braking deceleration can thus be initiated.

DE 10 2007 003 741 A1, which is incorporated by reference, discloses a method for operating a negative-pressure-type brake booster of a vehicle brake system, having a housing which is divided by a movable partition (or a diaphragm) into at least one negative-pressure chamber and at least one working chamber. A sensor unit senses the pressure in the negative-pressure chamber and transmits this to an electronic control unit which calculates the run-out point of the negative-pressure-type brake booster solely on the basis of the pressure prevailing in the negative-pressure chamber. The run-out point refers to a state in which a further increase in the brake pressure can be realized only through an increase in the pedal force, because the negative-pressure-type brake booster has reached the maximum possible assistance force. To determine possible defects of the sensor unit or of the negative-pressure-type brake booster (or of the vacuum pump), a plausibility check of the pressure value measured by the sensor unit is performed by virtue of a model being formed which, on the basis of empirically determined data and in conjunction with flow and thermodynamic processes, estimates the state variables in the negative-pressure chamber and in the working chamber.

### SUMMARY OF THE INVENTION

An aspect of the present invention makes it possible to perform an estimation or plausibility check of the pressure difference in a brake booster in a manner independent of a sensor for detecting the pressure in at least one chamber of the brake booster.

An aspect of the invention is a method for operating a brake system having a brake booster which is divided into at least one negative-pressure chamber and at least one working chamber by at least one movable partition, wherein at least one negative-pressure chamber is or can be connected to a negative-pressure source for the build-up of a negative pressure, and having at least one sensor which detects at least one variable such as travel and/or angle and/or force of a brake pedal actuation and/or a brake pressure that is built up, in accordance with a brake pedal actuation, in at least one master brake cylinder that is connected to the brake booster, wherein an estimation of the remaining negative pressure in at least one negative-pressure chamber is performed on the basis of at least one of the detected variables taking into consideration past brake pedal actuations.

Provision is thus made of a method for operating a brake system having a brake booster which is divided into at least one negative-pressure chamber and at least one working chamber by at least one movable partition, wherein at least one negative-pressure chamber is or can be connected to a negative-pressure source for the build-up of a negative pressure, and having at least one sensor which detects at least one variable such as travel and/or angle and/or force of a brake pedal actuation and/or a brake pressure that is built up, in accordance with a brake pedal actuation, in at least one master brake cylinder that is connected to the brake booster. According to the invention, an estimation of the remaining negative pressure in at least one negative-pressure chamber is performed on the basis of at least one of the detected variables taking into consideration past brake pedal actuations.

Here, a calibration, performed for example on the basis of measurements, of the relationship between brake pedal actuation and vacuum in the negative-pressure chamber of the brake booster is utilized to perform an estimation of the available negative pressure in a manner independent of a pressure sensor in the negative-pressure chamber or of a vacuum sensor. The complete or partial replacement of the vacuum sensors, which are typically used in simplex or redundant configuration, with the direct detection of the driver demand by measurement for example on the basis of brake pedal travel or brake pedal force has numerous advantages:
A hitherto used redundant measurement value detection of the vacuum or pressure in the negative-pressure chamber can be simplified by making joint use of sensors already provided for other purposes. This reduces the costs of the brake system without a decrease in reliability.
In addition to the omission or replacement of an otherwise required vacuum sensor with another measurement variable that reflects the driver demand, the number of connection pins or sensor inputs in the control unit can also be reduced, whereby costs are further reduced.
Furthermore, both the overall weight of the system and also the required structural space are reduced, such that vehicles with the same function can be made smaller and more lightweight, which increases both agility and also environmental compatibility.

It is expediently provided that, in accordance with or proportionally to at least one of the detected variables, a braking torque is generated by virtue of at least one electric drive of the vehicle being operated as a generator and/or by virtue of a brake pressure being built up in at least one wheel brake of the vehicle by means of a master brake cylinder that is connected to the brake booster. Vehicles with a fully or partially electric drive expediently have a pedal angle sensor or a pedal travel sensor for detecting the driver demand in order, in the case of light deceleration, to permit purely regenerative braking with correspondingly high recuperation efficiency. Said sensor is thus a suitable sensor for the estimation of the remaining negative pressure in accordance with the method according to the invention, which sensor is provided already without additional costs.

The taking into consideration of past brake pedal actuations for the estimation of the remaining negative pressure includes an integration or summation over multiple temporally successive values of at least one of the detected variables. The required development and production outlay is reduced considerably in relation to a system with a redundant sensor or with complex model calculation.

It is particularly preferable if the estimated remaining negative pressure decreases as the presently determined sum or presently determined integral over multiple temporally successive values of at least one of the detected variables increases. The configuration of the brake system is very particularly preferably taken into consideration by virtue of a characteristic curve being evaluated which permits a calibration of the relationship between the summed variable or the integral over the variable and the remaining negative pressure. Such a characteristic curve may be determined through measurements or calculated from known parameters, which describe for example the geometry of the brake system. If the influence of multiple parameters has been determined, this may be stored in the memory of a control unit in the form of a characteristic map.

It is particularly preferable if at least one negative-pressure chamber is connected to a motor-pump assembly which, as sole or additional negative-pressure source, builds up a negative pressure in the negative-pressure chamber when activated, and the motor-pump assembly is activated if the sum or the integral of at least one of the detected variables over one or more brake pedal actuations exceeds an actuation threshold value. It is thus possible to provide demand-controlled activation of a motor-pump assembly for maintaining a negative pressure in at least one chamber of a brake booster even without a sensor for detecting the pressure in at least one chamber of the brake booster.

The motor-pump assembly is very particularly preferably operated for at least one first time period. Through suitable selection of the first time period, the saturation pressure can be fully or approximately attained without the motor-pump assembly being operated permanently.

It is particularly preferable if at least one negative-pressure chamber of the brake booster is connected to a pressure sensor and to a motor-pump assembly which, as sole or additional negative-pressure source, builds up a negative pressure in the negative-pressure chamber when activated, and the motor-pump assembly is activated if the measured pressure in the negative-pressure chamber exceeds a first negative-pressure threshold value. If a pressure sensor or vacuum sensor is provided which measures the pressure or negative pressure in at least one negative-pressure chamber, the motor-pump assembly can be actuated on the basis of the measured pressure. The inventive taking into consideration of past actuations on the basis of at least one variable, such as for example the pedal angle, then expediently forms a fall-back solution for increasing reliability.

The motor-pump assembly is very particularly preferably operated until the measured pressure in the negative-pressure chamber falls below a second negative-pressure threshold value, wherein the second negative-pressure threshold value preferably corresponds to a lower absolute pressure than the first negative-pressure threshold value. By means of said hysteresis in the actuation of the motor-pump assembly, demand-oriented actuation of the motor-pump assembly is realized which brake boosting without the energy consumption and possible losses in comfort (such as noises) of permanent operation of the motor-pump assembly.

It is particularly preferable if the presently determined sum or presently determined integral over multiple temporally successive values of at least one of the detected variables is reset to the value zero after the motor-pump assembly has been operated for at least a first time period and/or has been operated until the measured pressure in at least one chamber falls below a second negative-pressure threshold value. If it is ensured that sufficient negative pressure is present, the taking into consideration of past actuations, or the regulation cycle, can begin again.

It is advantageous if two sensors suitable for determining a brake pedal actuation, in particular a sensor for detecting the brake pedal angle or brake pedal travel and/or a travel sensor on the master brake cylinder and/or a sensor for detecting the built-up brake pressure, are provided, and if a comparison of the sensor data is performed. Here, sensors required for other reasons, for example for the operation of a generator, may be incorporated into the actuation of the motor-pump assembly, whereby a fall-back solution independent of a pressure sensor is provided, and redundant estimation of the remaining negative pressure takes place. Here, reliability is increased with minimal cost outlay.

In a preferred embodiment of the invention, by means of an additional pressure source that can be connected to the master brake cylinder, a build-up of braking torque in at least one wheel brake of the vehicle is effected if the motor-pump assembly has been activated for a least a second time period without the pressure in at least one chamber falling below a second negative-pressure threshold value, or if the boost, determined from a comparison of the sensor data, of the brake booster falls below a predefined boost threshold value. It is thus possible in the event of a defect of the motor-pump assembly or of the brake booster for the braking action imparted by the driver to be assisted, for example by means of a hydraulic pump.

A warning is expediently output to the driver, in particular by means of a signal lamp, if the estimated remaining negative pressure in at least one negative-pressure chamber falls below a minimum threshold value with a frequency greater than a predetermined frequency threshold value. Because the driver is not immediately notified of isolated occurrences in which a negative pressure is estimated as being too low, the driver is not unduly disturbed if, for example, a brief fault arises in a sensor signal. If such a fault occurs more frequently, however, such that a frequency threshold value for the occurrence of said fault is exceeded, the driver is warned and can, for example, visit a workshop.

The invention also relates to a brake system for a motor vehicle, comprising a brake booster which is divided into at least one negative-pressure chamber and at least one working chamber by at least one movable partition, wherein at least one negative-pressure chamber is or can be connected to a negative-pressure source for the build-up of a negative pressure, comprising a motor-pump assembly as sole or additional negative-pressure source, comprising at least one master brake cylinder which is connected to the brake booster and in which brake pressure is built up in accordance with a brake pedal actuation, comprising at least one wheel brake which is connected to a master brake cylinder, and comprising at least one sensor which detects at least one variable such as travel and/or angle and/or force of a brake pedal actuation and/or a built-up brake pressure. According to the invention, the brake system also has an electronic control unit which is connected to at least one of the sensors for detecting brake pedal actuation and/or brake pressure and which carries out a method as claimed in at least one of the preceding claims.

It is preferable if both a sensor which detects the pedal angle or pedal travel of a brake pedal actuation and also a sensor for detecting the built-up brake pressure are provided, and the electronic control unit is connected to both. It is thus possible for sensors that are commonly provided in any case to be used for a redundant actuation of the motor-pump assembly or comprehensive monitoring of the function of the brake booster.

It is advantageous if a hydraulic pump is provided which can be connected to at least one wheel brake. In the case of a defect of the brake booster or if the run-out point is reached, an additional braking torque can be built up by means of a hydraulic pump which is commonly provided in any case for example for the provision of driving dynamics regulation.

The invention also relates to the use of a brake system according to the invention in a motor vehicle which is driven by an internal combustion engine and/or at least one electric machine. A pedal travel or pedal angle sensor that is required in vehicles with at least partially electric drive is particularly suitable for the taking into consideration of past actuation processes.

### BRIEF DESCRIPTION OF THE DRAWINGS

The invention is best understood from the following detailed description when read in connection with the accompanying drawings. Included in the drawings is the following Figs:

FIG. 1 shows an exemplary embodiment of a motor vehicle brake system,

FIG. 2 shows a master brake cylinder with vacuum-type brake booster connected upstream,

FIG. 3 shows a diagram of the negative pressure in a vacuum-type brake booster during multiple successive braking processes, and

FIG. 4 shows an exemplary embodiment of a method according to the invention for the actuation of an electric vacuum pump.

### BRIEF DESCRIPTION OF THE PREFERRED EMBODIMENTS

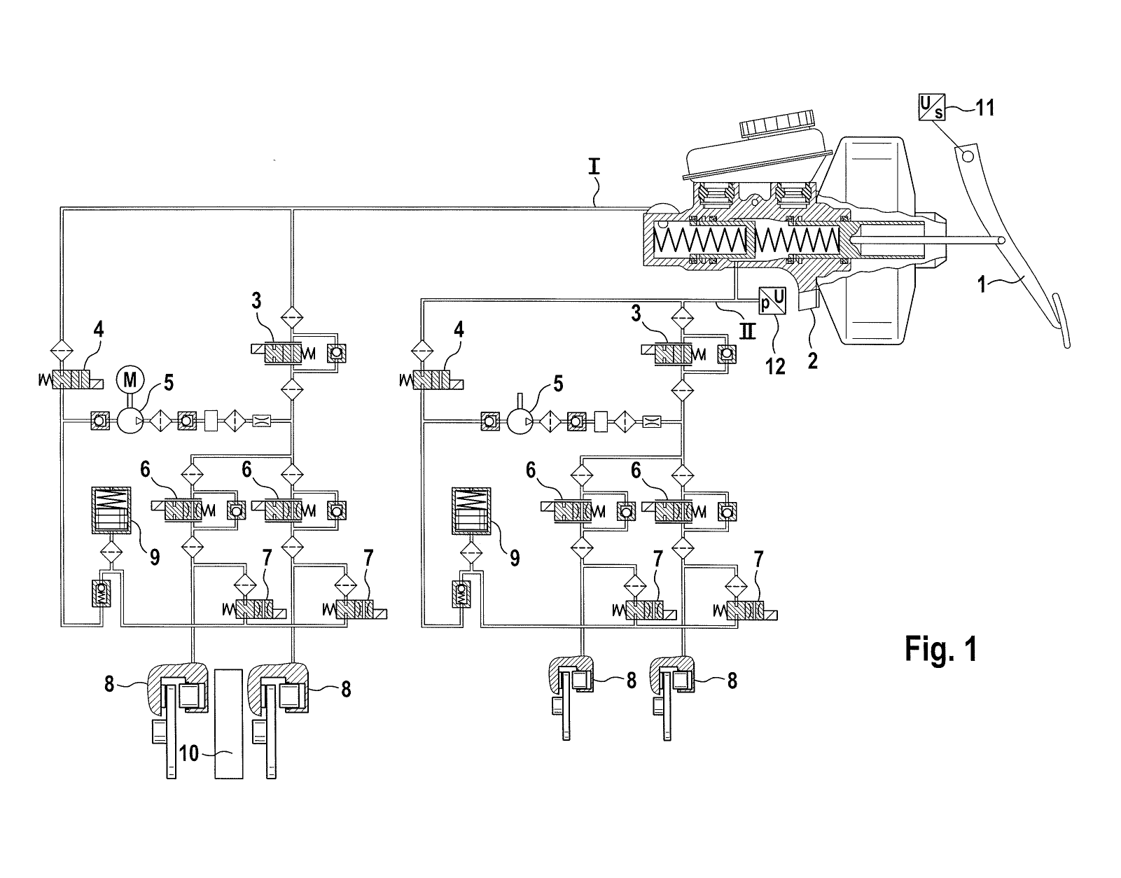

FIG. 1 shows an exemplary embodiment of a motor vehicle brake system which is suitable for carrying out the method according to the invention. The brake pedal 1 which is actuated by the driver acts directly on a tandem master brake cylinder 2 which is operated with auxiliary force, that is to say in which the actuation force imparted by the driver is boosted by a vacuum-type brake booster. The tandem master brake cylinder builds up pressure in two substantially identical brake circuits I and II, wherein these may be assigned to the wheels either on an axle basis or diagonally. The brake fluid flows through isolating valves 3 and inlet valves 6 into the wheel brakes or wheel brake cylinders 8 which build up a braking torque at the wheels. If the outlet valves 7 are opened, brake fluid can be discharged into the low-pressure accumulator 9. Through activation of the hydraulic pumps 5, a driver-independent pressure build-up in one or more wheel brakes is made possible, wherein, for this purpose, the electronic switchover valves 4 are opened and the isolating valves 3 are closed.

The brake system shown is a regenerative brake system which permits a recuperation of braking energy. For this purpose, there is situated on one of the axles an electrical generator 10 which permits electrically regenerative braking. Here, the deceleration demand of the driver is detected on the basis of a pedal angle sensor connected to the brake pedal or on the basis of a pedal travel sensor 11, and the generator braking torque is regulated correspondingly. To increase the efficiency of the recuperation, in a range of light deceleration, the braking torque is built up only by the generator. A pedal sensation that is acceptable to the driver can then be provided by virtue of one or both low-pressure accumulators 9 accommodating a volume of brake fluid that would generate the corresponding deceleration in the wheel brakes. The method according to the invention may however also be performed with a brake system without an electrical generator.

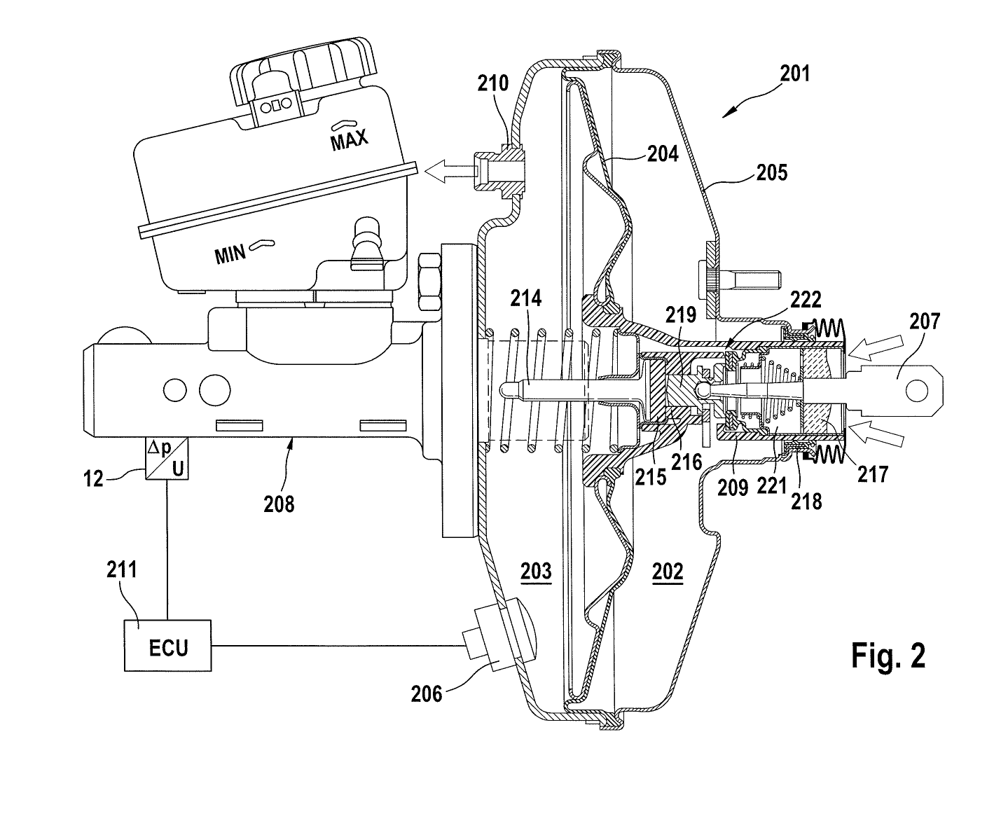

FIG. 2 shows a master brake cylinder 208 with a vacuum-type or negative-pressure-type brake booster 201, also referred to as “booster”, connected upstream. The negative-pressure-type brake booster 201 has a housing 205 which is divided into a working chamber 202 and a negative-pressure chamber 203. This is realized by a movable partition 204 which is provided with an axially movable rubber diaphragm. Arranged centrally in the negative-pressure-type brake booster 201 is a control hub 209, the function of which will be explained in more detail below. The outputting of force takes place via a force output element 214 which is supported via a reaction disk 215 on a step 216. On the other side, the control hub 209 extends through the housing 205 and is axially open to the atmosphere via a filter 217. The working chamber 202 is sealed off with respect to the environment by means of a seal 218 that is inserted with a form fit. The transmission of force to the reaction disk 215 takes place via a valve piston 219 which is clamped onto a ball head of a piston rod 207.

The piston rod 207 projects through an air chamber 221 and is connected to an actuation pedal (not illustrated). In the air chamber 221 there is inserted a disk valve 222 through which the piston rod 207 projects. The disk valve 222 is arranged so as to divide the air chamber 221 from the booster interior, as is the case in the rest position, illustrated here, of the negative-pressure-type brake booster 201. In said rest position, the air supply to the working chamber 202 is shut off. A negative pressure thus prevails in the working chamber 202 because the working chamber 202 is connected via openings to the negative-pressure chamber 203 and because the negative-pressure chamber 203 is connected via a negative-pressure port 10 to a negative-pressure source (not illustrated), preferably an electric vacuum pump. The pressure in the negative-pressure chamber 203 is measured by means of a sensor unit 206.

If a brake pedal that is connected to the piston rod 207 is actuated and thus the piston rod 207 and the valve piston 219 are displaced, the disk valve 222 is actuated and the negative-pressure chamber 203 and the working chamber 202 are no longer connected to one another. During the further course of the movement, a connection between the working chamber 202 and the outside air is opened by means of the disk valve 222. Owing to the pressure difference, which acts on the movable partition 204, between the working chamber 202 and the negative-pressure chamber 203, the input force at the brake pedal is assisted, and a master brake cylinder 208 connected downstream of the negative-pressure-type brake booster 201 is actuated via the force output element 214. In said readiness position, any small change in the pedal force results in an increase or decrease in the pressure difference on the two sides of the partition 204 and, via the master brake cylinder 208, generates an increase or reduction of the hydraulic pressure in the brake system and thus effects regulated braking of the motor vehicle.

The maximum possible assistance force of the negative-pressure-type brake booster 201 is provided when the working chamber 202 is fully aerated and atmospheric pressure prevails. This state is referred to as the run-out point. At the run-out point, therefore, the maximum pressure difference between the working chamber 202 and the negative-pressure chamber 203 has been reached. A further increase in the force on the master brake cylinder piston which adjoins the force output element 214 can be realized only through the exertion of an even greater pedal force by the driver, wherein a further increase in the hydraulic pressure in the brake system takes place only without boosting. This has the effect that, after the run-out point has been overshot, a further increase in braking force requires a significantly increased exertion of force on the brake pedal.

To eliminate said problem, it is known to switch over to a hydraulic boosting facility, and to activate a hydraulic pump which builds up an additional brake pressure, when the run-out point is reached. For said additional braking assistance, however, it is necessary for the run-out point to be precisely identified in order for the additional hydraulic boosting to be activated when required. Since the negative-pressure-type brake booster 201 has only one pressure sensor 206 for determining the pressure in the negative-pressure chamber 203, the run-out point is estimated or calculated.

Defects of the pressure sensor 206 must not lead to an erroneous identification of the run-out point, and an excessively high pressure (or lack of negative pressure) in the negative-pressure chamber must be reliably identified. Therefore, it is preferable for a plausibility check of the pressure value measured by the sensor unit 206 to be performed, and possible defects of the sensor unit 206 or of the negative-pressure-type brake booster 201 are determined, that is to say sensor faults or a failure of the negative-pressure-type brake booster 201 are reliably identified, whereby suitable countermeasures can be implemented and/or a warning can be output to the driver.

To attain a high boost action in a small structural space, the brake system may also comprise a tandem brake booster which corresponds to two vacuum-type brake boosters connected in series and which thus has two negative-pressure chambers and two working chambers. The method according to the invention can also be used correspondingly in the case of said tandem brake boosters.

During every brake actuation, the vacuum-type brake booster “consumes” a certain amount of its vacuum reservoir, that is to say the pressure in the negative-pressure chamber 203 increases.

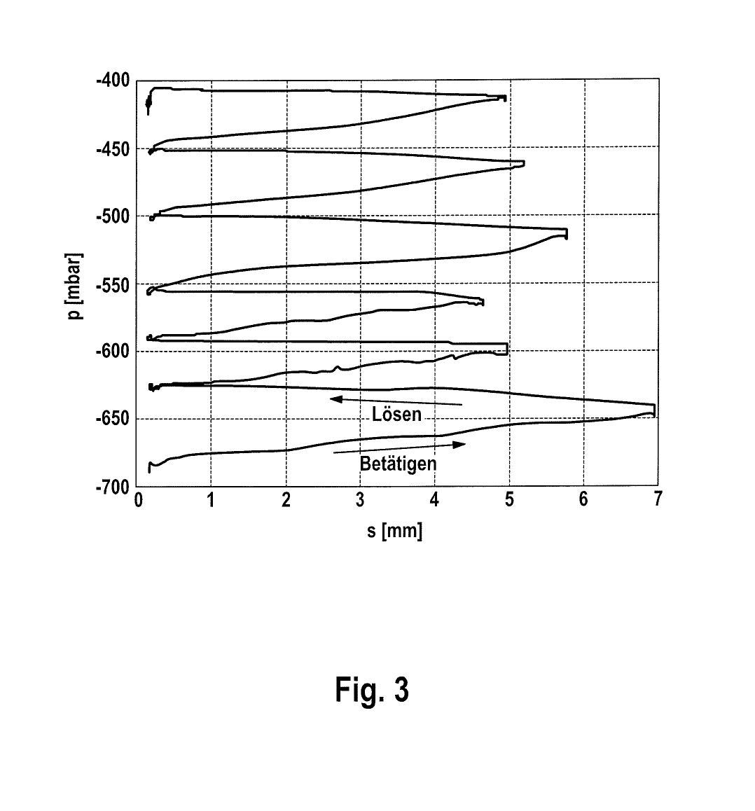

FIG. 3 shows a diagram of the negative pressure in a vacuum-type brake booster during multiple successive braking processes if no negative-pressure source is active. Plotted on the ordinate is the pressure p in the negative-pressure chamber in relation to the atmospheric pressure, that is to say, at a negative pressure of 0 mbar, no further brake assistance would take place, whereas for example a pressure p of −680 mbar or a negative pressure of 680 mbar, wherein the pressure in the negative-pressure chamber lies 680 mbar below atmospheric pressure, ensures optimum auxiliary-force assistance in this example. The abscissa indicates the displacement travel s of the master brake cylinder, wherein a greater travel corresponds to a more intense brake actuation, that is to say a greater pedal force and a higher pressure in the master brake cylinder. The arrow “actuation” indicates the increase in the displacement travel with more intense brake actuation, whereas the arrow “release” indicates the release of the brake pedal by the driver. Instead of a master brake cylinder travel sensor, it would correspondingly also be possible to use a pedal force sensor or pedal angle sensor on the brake pedal.

It can be seen in the diagram that a more intense brake pedal actuation or a greater displacement travel of the master brake cylinder also leads to a correspondingly greater pressure rise in the negative-pressure chamber. To be able to provide a uniform brake boosting action during every braking operation, the negative-pressure chamber must therefore be connected to a negative-pressure source, for example a vacuum pump.

In the case of conventional Otto-cycle engines, the intake pipe of the internal combustion engine serves as a negative-pressure source, whereas diesel engines commonly use a mechanically driven vacuum pump. These operate continuously, whereby the negative-pressure level is kept permanently at an approximately constant value and thus always provides the greatest possible auxiliary force. In some brake system configurations, however, the negative-pressure generation is performed exclusively or additionally by means of an electric vacuum pump (EVP). This makes it possible, for example in the case of hybrid vehicles with an electric auxiliary drive, for the internal combustion engine to be temporarily shut down in order to be able to drive exclusively under electric motor power for the purpose of reducing or eliminating emissions (this is also referred to as “sailing operation”). In order that, in sailing operation, the full brake boosting action is ensured even after multiple braking maneuvers, the electric vacuum pump is activated and evacuates the negative-pressure chamber. To avoid permanent operation of the electric vacuum pump in this case, the regulation thereof is preferably in the form of a hysteresis circuit with an upper and a lower switching point, wherein the signal of a vacuum sensor is evaluated. The vacuum pump regulation ensures that a certain negative-pressure level is always available as an energy source for the brake booster, even when the internal combustion engine is not in operation.

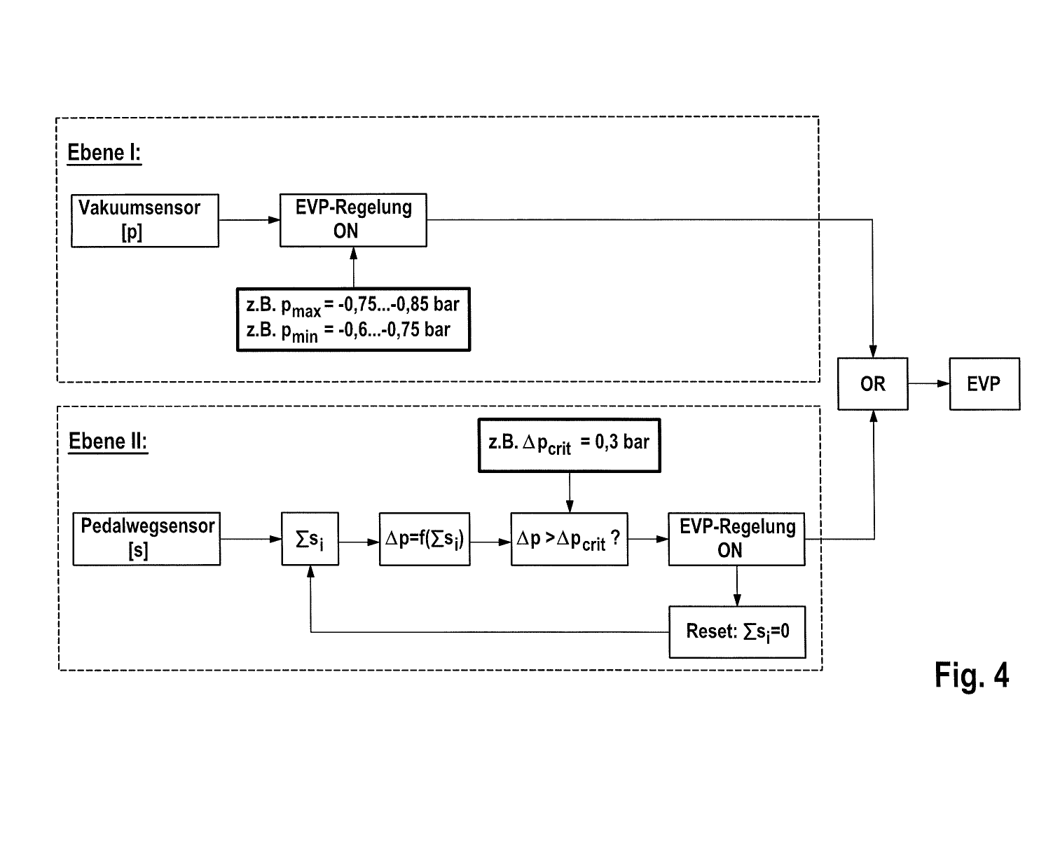

FIG. 4 shows an exemplary embodiment of a method according to the invention for the actuation of an electric vacuum pump, wherein the level I is not required in all embodiments of the invention.

If the demands on reliability are not very stringent, because for example in a lightweight vehicle a braking deceleration adequate for satisfying legal specifications or technical standards can be built up even without brake boosting, the actuation of an electric vacuum pump may be realized exclusively by means of the method designated as level II:

A pedal travel sensor detects the actuation travel s of the brake pedal and transmits the output signal to an evaluation unit, in particular a control unit of an electronically regulated brake system. The evaluation unit registers every pedal actuation, wherein the determined actuation travel is summed Σsᵢ and is converted, preferably with the aid of a characteristic curve stored in the evaluation unit or a characteristic map, into a vacuum consumption Δp within the brake booster. Said characteristic curve may for example have been measured previously in a calibration setup. If the summed actuation travel Σsᵢ exceeds a predefined actuation threshold value or the calculated vacuum consumption Δp exceeds a defined critical threshold Δp_{crit}, the electric vacuum pump EVP is activated. The latter builds up a negative pressure, or reduces the pressure, in the at least one negative-pressure chamber until a saturation pressure is attained, which saturation pressure thus corresponds to the vacuum that can be attained under the present conditions. Thus, after the EVP has been running for a certain length of time, the negative-pressure level in the brake booster has been restored, and the EVP can be deactivated again. Subsequently, the actuation integral Σsᵢ and/or the calculated vacuum consumption Δp is reset to zero, and the described regulation cycle subsequently begins again.

The described method makes it possible to dispense with the use of a vacuum sensor for the actuation of the vacuum pump, resulting in reduced production outlay and lower costs.

In an alternative embodiment of the method according to the invention and of the brake system according to the invention, the taking into consideration of past brake pedal actuations may also be implemented on the basis of the output signals of a pedal angle sensor or of a pedal force sensor.

In a further embodiment of the method according to the invention or of the brake system according to the invention, the taking into consideration of past brake pedal actuations is performed on the basis of a pressure sensor which detects the hydraulic pressure in the master brake cylinder or in a brake circuit connected to said master brake cylinder.

On the basis of the configuration of the brake system and/or on the basis of calibration measurements performed under controlled conditions, it is possible here to determine, for example, a hydraulic pressure-volume characteristic map.

In one particularly preferred embodiment of the invention, both a sensor for detecting the brake pedal angle and also a sensor for detecting the hydraulic pressure in the master brake cylinder are provided. It is then possible for both variables to be taken into consideration independently of one another for the actuation of the electric vacuum pump, whereby a second fall-back solution is made available. From a comparison of the master brake cylinder pressure with the brake pedal angle, however, it is also possible to identify when the run-out point of the brake booster is reached, such that for example a hydraulic pump can be activated for the purpose of braking assistance.

In some cases—for example in the case of heavy vehicles—the safety concept of the brake system may necessitate further monitoring measures and/or redundancies with regard to the actuation of a vacuum pump in order to ensure a minimum negative-pressure level in all operating states of the brake system and thus, in order to satisfy legal or technical specifications, a minimum braking capability.

Therefore, in a preferred exemplary embodiment of the invention, a redundant actuation of an electric vacuum pump is performed both with the method presented in level I and also with the method presented in level II.

In level I, a vacuum sensor detects the pressure p in at least one negative-pressure chamber of the brake booster. If the pressure p exceeds a first negative-pressure threshold value pₘᵢₙ, that is to say the remaining negative pressure yields the likelihood of a decrease in the boost action, the electric vacuum pump is activated. In relation to atmospheric pressure, the first negative-pressure threshold value pₘᵢₙ may for example lie between −600 mbar and −750 mbar. The electric vacuum pump decreases the pressure in the brake booster, wherein said pressure approaches a saturation pressure, that is to say a maximum attainable negative pressure, which is influenced by the suction capacity of the vacuum pump and by the leakage rate of the negative-pressure chamber. When the pressure p has fallen below a second negative-pressure threshold value pₘₐₓ the electric vacuum pump is deactivated. In relation to atmospheric pressure, the second negative-pressure threshold value pₘₐₓ may for example lie between −750 mbar and −850 mbar. By virtue of the regulation operating with hysteresis, the frequency of the activation of the electric vacuum pump decreases, wherein in each case a vacuum sufficient for multiple braking operations is provided in the negative-pressure chamber.

In parallel, and independently, the already-described actuation in level II takes place on the basis of a consideration of past brake pedal actuations. It is expedient for the electric vacuum pump EVP to be activated whenever at least one of the two regulation levels outputs an activation signal for the EVP (this is indicated in the drawing by the box “OR”). Thus, in each case, another fall-back solution is provided if one of the two actuation methods fails for example owing to a defect of the vacuum sensor. Safe and comfortable actuation of the brake system by the driver is ensured.

1. A method for operating a brake system having a brake booster which is divided into at least one negative-pressure chamber and at least one working chamber by at least one movable partition, wherein at least one negative-pressure chamber is or can be connected to a negative-pressure source for the build-up of a negative pressure, and having at least one sensor which detects at least one variable such as travel and/or angle and/or force of a brake pedal actuation and/or a brake pressure that is built up, in accordance with a brake pedal actuation, in at least one master brake cylinder that is connected to the brake booster, wherein an estimation of the remaining negative pressure in at least one negative-pressure chamber is performed on the basis of at least one of the detected variables taking into consideration past brake pedal actuations.

2. The method as claimed in claim 1, wherein in accordance with or proportionally to at least one of the detected variables, a braking torque is generated by virtue of at least one electric drive of the vehicle being operated as a generator and/or by virtue of a brake pressure being built up in at least one wheel brake of the vehicle by means of a master brake cylinder that is connected to the brake booster.

3. The method as claimed in claim 1, wherein the taking into consideration of past brake pedal actuations for the estimation of the remaining negative pressure includes an integration or summation over multiple temporally successive values of at least one of the detected variables.

4. The method as claimed in claim 3, wherein the estimated remaining negative pressure decreases as the presently determined sum or presently determined integral over multiple temporally successive values of at least one of the detected variables increases, wherein for calibration, a characteristic curve or characteristic map is preferably evaluated.

5. The method as claimed in claim 3, wherein at least one negative-pressure chamber is connected to a motor-pump assembly which, as sole or additional negative-pressure source, builds up a negative pressure in the negative-pressure chamber when activated, and in that the motor-pump assembly is activated if the sum or the integral of at least one of the detected variables over one or more brake pedal actuations exceeds an actuation threshold value.

6. The method as claimed in claim 5, wherein the motor-pump assembly is operated for at least one first time period.

7. The method as claimed in claim 3, wherein at least one negative-pressure chamber is connected to a pressure sensor and to a motor-pump assembly which, as sole or additional negative-pressure source, builds up a negative pressure in the negative-pressure chamber when activated, and in that the motor-pump assembly is activated if the measured pressure in the negative-pressure chamber exceeds a first negative-pressure threshold value.

8. The method as claimed in claim 7, wherein the motor-pump assembly is operated until the measured pressure in the negative-pressure chamber falls below a second negative-pressure threshold value, wherein the second negative-pressure threshold value preferably corresponds to a lower absolute pressure than the first negative-pressure threshold value.

9. The method as claimed in claim 3, wherein the presently determined sum or presently determined integral over multiple temporally successive values of at least one of the detected variables is reset to the value zero after the motor-pump assembly has been operated for at least a first time period and/or has been operated until the measured pressure in the negative-pressure chamber falls below a second negative-pressure threshold value.

10. The method as claimed in claim 1, wherein two sensors suitable for determining a brake pedal actuation, in particular a sensor for detecting the brake pedal angle or brake pedal travel and/or a travel sensor on the master brake cylinder and/or a sensor for detecting the built-up brake pressure, are provided, and in that a comparison of the sensor data is performed.

11. The method as claimed in claim 7, wherein by means of an additional pressure source that can be connected to the master brake cylinder, a build-up of braking torque in at least one wheel brake of the vehicle is effected if the motor-pump assembly has been activated for a least a second time period without the pressure in the negative-pressure chamber falling below a second negative-pressure threshold value, or if the boost, determined from a comparison of the sensor data, of the brake booster falls below a predefined boost threshold value.

12. The method as claimed in claim 1, wherein a warning is output to the driver if the estimated remaining negative pressure in at least one negative-pressure chamber falls below a minimum threshold value with a frequency greater than a predetermined frequency threshold value.

13. A brake system for a motor vehicle, comprising a brake booster which is divided into at least one negative-pressure chamber and at least one working chamber by at least one movable partition, wherein at least one negative-pressure chamber is or can be connected to a negative-pressure source for the build-up of a negative pressure, comprising a motor-pump assembly as sole or additional negative-pressure source, comprising at least one master brake cylinder which is connected to the brake booster and in which brake pressure is built up in accordance with a brake pedal actuation, comprising at least one wheel brake which is connected to a master brake cylinder, and comprising at least one sensor which detects at least one variable such as travel and/or angle and/or force of a brake pedal actuation and/or a built-up brake pressure, wherein an electronic control unit which is connected to at least one of the sensors for detecting brake pedal actuation and/or brake pressure and which carries out a method claim 1.

14. The brake system as claimed in claim 13, wherein both a sensor which detects the pedal angle or pedal travel of a brake pedal actuation and also a sensor for detecting the built-up brake pressure are provided, and the electronic control unit is connected to both.

15. The brake system as claimed in claim 13, wherein a hydraulic pump is provided which can be connected to at least one wheel brake.

16. The use of a brake system as claimed in claim 13 in a motor vehicle which is driven by an internal combustion engine and/or at least one electric machine.
